(19) United States
(12) Patent Application Publication
(10) Pub. No.: US 2004/0158615 A1
(43) Pub. Date: Aug. 12, 2004

(54) Priority web browsing

(76) Inventors: Matthew Craig Keller, Algonquin, IL (US); Donald G. Newberg, Hoffman Estates, IL (US)

Correspondence Address: Welsh & Katz, Ltd., Jon P. Christensen, 22nd Floor, 120 South Riverside Plaza, Chicago, IL, 60606, US

(21) Appl. No.: 10/364,937

(22) Filed: Feb. 12, 2003

(51) Int. Cl. G06F 15/16

(52) U.S. Cl. 709/207

(57) ABSTRACT

A method and apparatus are provided for prioritizing transfer of information between an IP network information resource and a client of the IP network. The method includes receiving an information request by the IP network information resource from the client, determining a priority of transfer of a response through the IP network based upon information associated with the request and prioritizing and sending the response from the information resource to the client by using IP network prioritization mechanisms to give the response the determined relative transfer priority. The apparatus preferably includes an IP network information resource, a memory, and a reverse web proxy.

### FIELD OF THE INVENTION

The field of the invention relates to the Internet and intranets, and more particularly to the transfer of information to and from websites.

### BACKGROUND OF THE INVENTION

The use of the Internet as an information resource is a well-known phenomenon. A user need only purchase a computer with a web browser and sign-up for service with an Internet Service Provider (“ISP”).

To search for information, the user may simply go to a search website (e.g., Yahoo, Google, etc.) and enter a search term. In response, the search website may download a web page with search results. The user may select a search term and ultimately be presented with one or more web pages of information. The user may download any information of interest at his/her convenience.

Recent improvements to Internet access have included the use of mobile terminals (e.g., personal digital assistants (“PDAs”)). Mobile terminals provide the functionality of the Internet through a portable device with a wireless interface.

While the Internet has become a convenient resource for some, it has become a necessary resource for others. For example, because of the diversity of software applications, such as web browsers, available for communicating through Internet protocol (“IP”) networks, many commercial and public service organization have migrated to intranets as a primary communication resource. In fact, many fire and police departments now provide portable data terminals in police and fire trucks as a means of supporting police and fire department activities. Special secure websites have been provided for use by such terminals.

In addition, the ability of IP networks (e.g., the Internet) to support many different types of traffic (e.g., text, graphics, etc.) allows virtually any file to be transferred to a user endpoint. When this ability is combined with a wireless interface the potential uses of mobile terminals becomes virtually unlimited. This combination of the mobile terminals and the IP network may be part of a larger communication system that supports a comprehensive suite of communications such as voice, video, and data.

While the migration of police and fire department communication facilities to IP networks has been successful, it is not without difficulty. For example, during periods of heavy IP network use, responses to critical queries are often delayed. While such delays are tolerated for the casual user, they cannot be tolerated where public safety is concerned. In addition to system load, other aspects of the state of the communication system such as the emergency status of users may indicate the need to differentiate between important network traffic and casual communications.

Accordingly, a need exists for a method of expediting communications over the IP network, particularly during periods of heavy IP network use or during periods of light use when large files from other sources are involved.

### BRIEF DESCRIPTION OF THE FIGURES

A preferred embodiment of the invention is now described, by way of example only, with reference to the accompanying figures in which:

FIG. 1 depicts a system for prioritizing transfer of information between an IP network information resource and a client of the IP network in accordance with an illustrated embodiment of the invention; and

FIG. 2 depicts a web page that may be used by the client of FIG. 1.

### DETAILED DESCRIPTION OF THE INVENTION

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements. A detailed description of the preferred embodiment and best modes for practicing the invention are described herein. It should be noted in this regard that the figures and description provided below are directed to a particular logical grouping of functionalities that may differ among specific applications without departing from the spirit of the invention.

An improved method and apparatus are provided for prioritizing transfer of information between an Internet protocol (“IP”) network information resource and a client on the IP network. The improved method includes receiving an information request by the IP network information resource from the client, determining a priority of a response transferred through the IP network based upon information associated with the request and prioritizing and sending the response from the IP network information resource to the client by using IP network prioritization mechanisms to give the response the determined priority of transfer.

The improved apparatus can include an IP network information resource, a memory and a reverse web proxy. A more detailed explanation of the present invention is provided in the following description and appended claims taken in conjunction with the accompanying drawings.

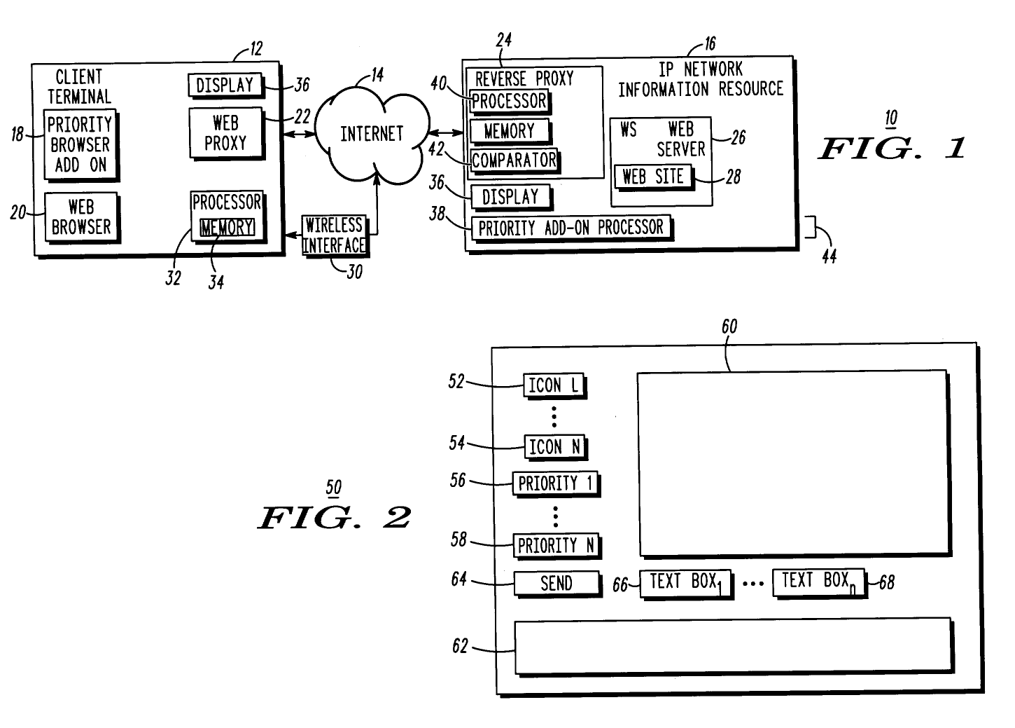

FIG. 1 depicts a web access system 10 that may be used by a priority user (client) on the IP network under an illustrated embodiment of the present invention. As used herein, a priority user is an individual or organization that by virtue of some organizational characteristic (e.g., public safety, economic contribution, etc.) is given a higher priority than a casual IP network user.

It should be noted that while a priority user will be the primary focus of the discussion below, it should also be noted that priority of transfers to the user may be based upon other, additional factors. For example, a priority of information to the user may be based upon the web page requested or a user context or system state.

Under the illustrated embodiment, a designated user working through a terminal (e.g., a portable unit) 12 may access a website 28 of a web server 26 under any of a number of different priority levels. The priority levels may be controlled directly by the user, by an IP network information resource 16 based upon communication system state, or by external factors related to use of the terminal 12 by the designated user.

It should be understood that the different priority levels may be provided as described below by the control modules shown in FIG. 1. The functionality of the individual control modules may be provided as hardware, firmware or software (or any combination thereof).

The terminal 12 may be coupled to the IP network 14 by wireline (as shown by the solid line in FIG. 1) or by a wireless interface 30. An appropriate protocol (e.g., hyper-text transfer protocol (HTTP), Wireless Application Protocol (WAP), etc.) may be used between the terminal 12 and the IP information resource 16.

Where connected by a wireless interface 30, the terminal 12 may be used in police cars or fire trucks. Where used in fire trucks, the terminal may have great value for such purposes as downloading drawings of buildings on fire or public records of toxic materials stored at specific addresses. Where used in police cars, the terminal 12 may be used to download records related to automobile license plates or rap sheets of suspects.

The IP network information resource 16 and web server 26 may be dedicated for use by the terminal 12 or may be part of a publicly accessible resource. Where the web server 26 is used by public safety agencies, access to the web server 26 and/or website 28 may be restricted to authorized terminals 12.

In general, and except as described below, the web browser 20 and website 28 may operate conventionally. Universal resource locators (“URLs”) may be entered through the terminal 12 and information may be downloaded in a manner well known in the art.

Turning now to the present invention, a description will be offered of the use of the system 10 in the context of a public safety environment. It should be understood, however, that the described concepts of use of the system 10 could be equally well applied to any other public or private entity or even to individual use in the proper context.

Upon activation of the terminal 12, a processor 32 within the terminal 12 may download a graphical user interface (“GUI”) for the benefit of the user of the terminal 12. The GUI, for example, may be a web page. The processor 32 may download the web page by executing a start-up routine that results in the transfer of the URL of a particular homepage within the website 28 to the browser 20 of the terminal 12.

Under normal operation, the browser 20 may compose an information request message and transfer the message through the IP network 14 to the website 28. The website 28 may respond by downloading the web page 50 as illustrated in FIG. 2. The web page 50, in turn, may be shown on the display 36.

The web page 50 may include a number of special function icons 52, 54, a set of priority selection icons/resources 56, 58 that may be used to select the priority of a web page request, an information display window 60 and a text entry window 62. In the case of use of the terminal 12 by the fire department, the text entry window 62 may be used to enter the address of a fire. One special function icon 52, 54 may be used to request a map showing a fire hydrant nearest the address of the fire. The information display window 60 may be used to display a map of hydrant locations surrounding a site of the fire.

In addition to the use of icons 52, 54, 56, 58, the web page 50 may also display one or more URLs 66, 68 of a specific predetermined priority for a specific function (e.g., communication with an emergency command center, dispatch center, etc.). The terminal 12 may also be provided with an external user access feature (e.g., a red button 44 on an outside of an enclosure of the terminal 12) to cause the system to assume a specific predetermined priority for all further exchanges during a particular session.

In non-emergency situations, the user may enter an address and simply activate the SEND button 64 and allow the map to be downloaded conventionally. In emergency situations, however, the user may utilize one of the previously described priority selection mechanisms which may result in a prioritization of the information request and response as described below. It should be noted in this regard that under one embodiment, the entire response, which may be made up of multiple response messages (e.g., text, images, etc.), may be given an elevated level of priority.

Under an illustrated embodiment, activation of a priority selection mechanism initiates a sequence of steps that results in a transfer of the relative priority of the request to the IP network prioritization mechanism of the transmission control layer of the IP network. The relative priority of a message (in this case the request message) is indicated to the IP network prioritization mechanisms of the transmission control layer. The message may be transmitted through the IP network in multiple packets whose packet transmission may be reordered based upon the relative priority of packets in a packet queue.

In prior art systems, the transmission priority determined by a server is typically set the same for all traffic of a particular type (regardless of the type of user request, user context, system context, etc.). As described herein, the transmission priority may be changed in any of these contexts (and even within the same context) to accommodate the exigency of the situation.

Control of packet priority in the IP network prioritization mechanisms of the transmission control layer may be based upon any of a number of different protocols (e.g., Type of Service (TOS), Diffserv information, etc.). In each case, packet priority information directed to the IP network prioritization mechanisms of the transmission control layer may be referred to as packet associated information since it is intended for use by a packet router instead of the packet target.

The creation and use of prioritization information may be handled as part of a two-step process. As a first step, the user indicates the desired priority through the priority selection mechanisms. In the second step, a priority browser add-on 18 may be used to add the selected priority level to a URL of the requested web page. The priority level may be attached to the URL (e.g., as a suffix) in the form “?priority=x”, where “x” is the selected priority level.

The URL (and attachment) is transferred to the browser 20. The browser 20 composes the request message in a conventional manner where the URL priority attachment is encoded in the request message. The composed message may then be transferred to a web proxy 22. The web proxy 22 functions as a communication intermediary between the terminal 12 and the IP network information resource 16.

Within the web proxy 22, the information request message is read and the attachment is removed from the URL in the information request. Removal of the attachment from the information request allows the web request to be later processed by the server 26 without uncertainty, yet still provides a convenient mechanism of communicating the priority to the web proxy 22.

Once the attachment is retrieved and processed, the web proxy 22 transfers the information request message and associated IP network transmission control layer information to the IP network 14. As the packets comprising the information request message are transferred through the IP network, the packet and packet associated information is read and processed. As part of the processing, the IP network transmission control layer reads the priority of the packets and prioritizes the transfer accordingly.

Within the IP network information resource 16, a call associated information processor 40 within a reverse proxy 24 may receive the information request along with the associated priority information. The processor 40 of the reverse proxy 24 may receive and store the associated priority information along with the identifier of the source (e.g., the IP address of the terminal 12). The reverse proxy 24 may also store a copy of the information request message or relevant parameters for matching purposes with a later response. The reverse proxy 24 may also pass the information request message to the web server 26 and website 28.

Within the website 28, the information request may be processed and an appropriate response generated. The response may be composed into an information response message or messages intended for the terminal 12.

The information response may then be transferred to the reverse proxy 24. A comparator 42 within the reverse proxy 24 may associate the response message with a previous information request by matching source and destination identifiers and thereby determine that the information response message is intended for the terminal 12. If the corresponding information request message was received under a predetermined priority level, the reverse proxy 24 may associate the same priority information to the information response message, thereby giving the response the same priority level during transmission through the IP network 14 as the information request message.

In another illustrated embodiment, the prioritization of IP network transmissions may be unilateral. For example, it is well known that information requests are usually much smaller than information responses therefore prioritization of the request might not be as beneficial as prioritization of the response.

In this case, the web proxy 22 in the terminal 12 may be omitted and the information requests transferred to the server 26 under a normal priority with the attachment (e.g., “?priority=x”) still present within the information request.

Within the reverse proxy 24, the information request received from the IP network device and its associated priority is stored for use with any information responses.

When a response is detected, the comparator 42 of the reverse proxy 24 searches its memory for an associated request and retrieves any corresponding entries regarding priority. If a match is found, then the reverse proxy 24 may use any associated priority information to control the priority of the transmission of the response that may then be sent to the terminal 12.

In yet another illustrated embodiment, the priority of the information response may be unilaterally controlled based upon the state of the IP network information resource 16. For example, in the public safety context, the IP network information resource 16 may determine that an emergency exists in a particular area where a terminal 12 is located and adjust the priority of communication with the terminal 12 accordingly.

In other, additional embodiments, the priority of responses may be adjusted based upon the web page requested. For example, if a fire department should request a web page of hazardous materials, then the priority of the response may be given a higher priority by the reverse proxy 24.

As another example, the priority of responses may be adjusted by a state of a communication system. For example, if an emergency is declared, then all responses may be prioritized.

As a still further example, the priority of a response may be based upon attributes of the client 12. In this case, the attributes may be identified characteristics of the client 12, such as the user's rank, emergency status, or location. Further, the attributes for adjusting a priority of transmission may be extended to (or even limited to) the IP address of any particular client 12. In either case, one or more attribute lists may be maintained within the reverse proxy 24 and message priority may be adjusted based upon a comparison of client attributes and the attribute lists. As above, the attribute list may contain the attributes for adjusting a priority and also the priority level to be given to clients 12 with attributes that match the attributes specified within the attribute list.

A specific embodiment of a method and apparatus for prioritizing transfer of information between an IP network server and a user has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

We claim:

1. A method of prioritizing transfer of information between an Internet protocol (“IP”) network information resource and a client on an IP network, such method comprising the steps of:
receiving an information request from the client;
determining a priority of a response to be transferred through the IP network based upon information associated with the information request; and
transmitting the response to the client using the priority.

2. The method of claim 1 wherein the step of transmitting utilizes at least one IP network prioritization mechanism.

3. The method of claim 1 wherein the step of determining the priority further comprises the steps of:
retrieving an attribute of the client from the information request; and
comparing the attribute to a list of client attributes.

4. The method of claim 1 wherein the step of determining the priority further comprises the steps of:
retrieving a universal resource locator (“URL”) from the information request; and
comparing the URL to a list of URLs.

5. The method of claim 1 further comprising the steps of:
storing the priority of the response; and
transmitting a subsequent response to the client using the priority.

6. The method of claim 1 wherein the information request comprises the priority of the response.

7. The method of claim 6 wherein the information request comprises a universal resource locator signaling the priority.

8. The method of claim 6 wherein the information request comprises IP network prioritization information signaling the priority.

9. The method of claim 1 wherein the response comprises a Web page.

10. The method of claim 1 wherein each step is implemented in at least one of hardware, firmware, and software.

11. The method of claim 1 wherein the client resides in a communication system, and wherein the step of determining is further based on a state of the communication system.

12. A method of prioritizing transfer of information between an Internet protocol (“IP”) network information resource and a client of an IP network, the method comprising the steps of:
determining a priority to be used by the IP network information resource;
transmitting an information request comprising the priority through the IP network; and
receiving a response from the IP network information resource, wherein the response was transmitted by the IP network information resource using the priority.

13. The method of claim 12 wherein the priority is determined from one of the following: a user selection mechanism, a universal resource locator, and a memory.

14. The method of claim 12 wherein the information request comprises IP network prioritization information, and the priority is signaled in the IP network prioritization information.

15. The method of claim 12 wherein the information request comprises a universal resource locator (“URL”), and wherein the priority is signaled in the URL.

16. The method of claim 12 wherein the information request is transmitted using the priority.

17. The method of claim 12 wherein the response is a Web page.

18. The method of claim 12 wherein each step is implemented in at least one of hardware, firmware, and software.

19. A storage medium having stored thereon a set of instruction which, when loaded into a hardware device, causes the hardware device to perform the following functions through the IP network:
receive an information request from the client;
determine a priority of a response to be transferred through the IP network based upon information associated with the information request; and
transmit the response to the client using the priority.

20. A storage medium having stored thereon a set of instruction which, when loaded into a hardware device, causes the hardware device to perform the following functions through the IP network:
determine a priority to be used by the IP network information resource;
transmit an information request comprising the priority through the IP network; and
receive a response from the IP network information resource, wherein the response was transmitted by the IP network information resource using the priority.
